(19) United States
(12) Patent Application Publication
(10) Pub. No.: US 2008/0084398 A1
(43) Pub. Date: Apr. 10, 2008

(54) USER INTERFACE, AND DIGITAL CAMERA

(76) Inventors: Makoto Ito, Saitama (JP); Yoichi Hirata, Kanagawa (JP); Masanobu Shibuya, Kanagawa (JP)

Correspondence Address: Frank Pincelli;Patent Legal Staff, Eastman Kodak Company, 343 State Street, Rochester, NY, 14650-2201, US

(21) Appl. No.: 11/622,563

(22) Filed: Jan. 12, 2007

(30) Foreign Application Priority Data
Oct. 4, 2006 (JP) 2006-273398

(51) Int. Cl. G06F 3/041; G09G 3/16; H04N 5/222

(52) U.S. Cl. 345/173; 345/48; 348/333.02

(57) ABSTRACT

There is provided a user interface which enables a reduction in the chance of occurrence of erroneous operation. A display used for displaying various items of information, a captured image, or the like, is provided in the back of a digital camera. A first touch strip and a second touch strip, which detect sliding actions of the user's fingers, are provided on respective sides of the display. A control section displays on a display screen a plurality of items required to perform menu setting, and switches between a selection position for a first-level hierarchical item according to sliding action detected by the first touch strip and a selection position for a second-level hierarchical item according to sliding action detected by the second touch strip.

### CROSS REFERENCE TO RELATED APPLICATIONS

This application claims priority to Japanese Patent Application No. 2006-273398 filed on Oct. 4, 2006, which is incorporated herein by reference in its entirety.

### FIELD OF THE INVENTION

The present invention relates to a user interface which is incorporated in a portable electronic device, provides the user with information, and accepts the user's operation, as well as to a digital camera equipped with the user interface.

### BACKGROUND OF THE INVENTION

Large numbers of portable electronic devices, such as digital cameras and portable game machines, have been in circulation in recent years. Strong desire for miniaturization exists for such a portable electronics device, whereas strong desire exists for an increase in the size of a display screen used for displaying various items of information provided for the user. Particularly, in the field of a playback monitor whose display screen reproduces and displays a captured image and a digital camera serving as an electronic finder used for ascertaining an image of a subject to be captured, strong desire exists for an increase in the size of the display screen. Consequently, a space in a portable electronic device where control buttons, or the like, are arranged is prone to decrease.

In the meantime, the portable electronic device has become multifunctional, and a large number of control buttons, or the like, used for operating or setting the portable electronic device are required. As mentioned previously, in relation to many of the portable electronic devices, a desire for miniaturizing the overall size of the device exists, but another desired to increase the size of a display screen also exists. Thus, the layout space for control buttons, and the like, is limited. Accordingly, numerous techniques for readily controlling an electronic device with a smaller number of keys have hitherto been proposed.

For instance, Japanese Patent Laid-Open Publication No. Hei 10-39991 describes a display controller which is provided with a tablet key which enables pressed actuation and slidable operation and controls selection of various setting items displayed on the display screen. Japanese Patent Laid-Open Publication No. Hei 11-288350 describes a key-in device provided with a menu key operation section used for selectively switching a plurality of high-level menu items, and a select key operation section used for selectively switching low-level menu items. By means of these devices, operation of the electronic device is facilitated to a certain extent.

However, the display controller described in Japanese Patent Laid-Open Publication No. Hei 10-39991 is intended to be incorporated into an electronic device having a comparatively small number of setting items, such as a monitor, a television receiver, or the like. In the case of an electronic device having a small number of setting items, no problem arises even when the device is equipped with a single tablet key. However, in the case of an electronic device having a large number of setting items, such as a digital camera, a game machine, and the like, difficulty is encountered in performing suitable operation through use of a single tablet key. Moreover, the key-in device described in Patent Document 2 involves a necessity for depressing a plurality of buttons with a single finger, and hence the amount of movement of the finger is apt to increase. In this case, the user must visually ascertain a position where the finger is to move, as required, which raises a problem of complicated, erroneous operation being likely to arise.

### SUMMARY OF THE INVENTION

Accordingly, the present invention provides a user interface capable of reducing the chance of occurrence of erroneous operation, and a digital camera equipped with the user interface.

The present invention provides a user interface which is provided in a portable electronic device, provides a user with information, and accepts operation from the user, the interface comprising:

a display screen for displaying information;

first and second slide detection units which form a pair for detecting sliding action of a user's finger and placed in the vicinity of right and left side edges of a display screen; and

a control unit which displays a plurality of items on the display screen and sequentially switches a selection position of an item according to the sliding action detected by the slide detection units.

In a preferred mode, the plurality of items are classified into a plurality of hierarchical strata; and the control unit sequentially switches a selection position of an odd-numbered hierarchical layer according to sliding action detected by the first slide detection unit and sequentially switches a selection position of an even-numbered hierarchical layer according to sliding action detected by the second slide detection unit. In this case, the first and second slide detection units can detect previously-defined determination operation; and the control unit preferably specifies, as a determination item, a high-level hierarchical item selected at a point in time when the slide detection unit corresponding to the high-level hierarchical item has detected determination operation, and displays low-level hierarchical items corresponding to the determination item. Moreover, when a slide detection unit corresponding to a high-level hierarchical item has detected sliding action during display of low-level hierarchical items, the control unit desirably aborts the display of the low-level hierarchical items and sequentially switches selection position of a high-level hierarchical item according to the sliding action. In another preferred mode, the control unit displays low-level hierarchical items corresponding to an item selected at a point in time when one is selected from the high-level hierarchical items.

In still another preferred mode, the control unit displays the plurality of items arranged in an array on the display screen, moves the selection position of an item in a first direction according to the sliding action detected by the first slide detection unit, and moves the selection position of an item in a second direction differing from the first direction according to the sliding action detected by the second slide detection unit.

In yet another preferred mode, the user interface preferably further comprises a vibration unit which vibrates the overall user interface in synchronism with operation of the user detected by the respective slide detection units. In this case, the vibration unit desirably changes at least one of amplitude and frequency of vibrations according to the speed of detected sliding action of the user.

In another preferred mode, the user interface further comprises a plurality of luminous elements disposed in the vicinity of the first slide detection unit and the second slide detection unit, wherein the control unit causes a luminous element, which is located in the vicinity of a slide detection unit and is desired to be actuated by the user, to illuminate according to the state of current operation, thereby guiding user's operation.

Another invention provides a digital camera having a display screen, comprising:

a release button for accepting an imaging command from a user;

first and second slide detection units which form a pair for detecting sliding action of a user's finger and placed in the vicinity of right and left side edges of a display screen; and

a control unit which displays on the display screen a plurality of items classified into a plurality of hierarchical strata, sequentially switches a selection position of an odd-numbered hierarchical item according to the sliding action detected by the first slide detection unit, and sequentially switches a selection position of an even-numbered hierarchical item according to sliding action detected by the second slide detection unit, wherein

the first slide detection unit is located more distant from the release button than is the second slide detection unit.

According to the present invention, the first slide detection unit and the second slide detection unit are disposed in the vicinity of respective ends of the display screen. Hence, the two operators can be actuated with fingers of both hands holding the electronic device. Even when operators to be actuated are provided at two separated locations, the amount of movement of the fingers becomes smaller, and the amount of shift of the line of sight is also reduced. Consequently, occurrence of an erroneous operation can be effectively diminished.

The invention will be more clearly comprehended by reference to the embodiments provided below. However, the scope of the invention is not limited to those embodiments.

### BRIEF DESCRIPTION OF THE DRAWINGS

Preferred embodiments of the present invention will be described in detail based on the following figures, wherein:

FIG. 1 is a rear view of a digital camera corresponding to an embodiment of the present invention;

FIG. 2 is a block diagram showing a general configuration of the digital camera;

FIG. 3 is a view showing an example configuration of menu items;

FIG. 4 is a flowchart showing the flow of menu setting operation;

FIG. 5 is a view showing the state of menu items achieved when a menu button has been pressed;

FIG. 6 is a view showing the state of menu items achieved at the time of determination of a first-level hierarchical item;

FIG. 7 is a view showing the state of menu items achieved at the time of selection of a third-level hierarchical item;

FIG. 8 is a rear view of a digital camera corresponding to another embodiment of the present invention;

FIG. 9 is a rear view of a digital camera corresponding to yet another embodiment of the present invention; and

FIG. 10 is a perspective view of the digital camera acquired when the digital camera is viewed from the front.

### DETAILED DESCRIPTION OF THE PREFERRED EMBODIMENTS

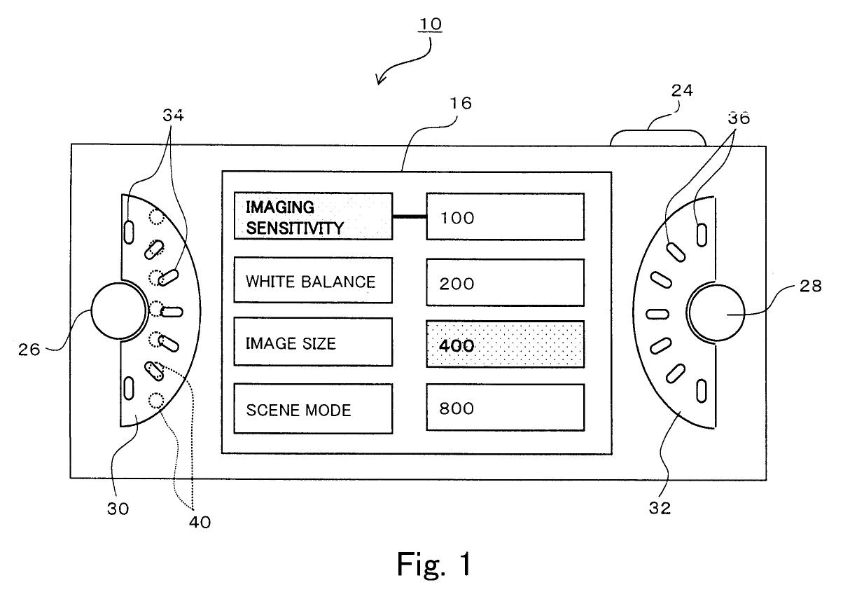

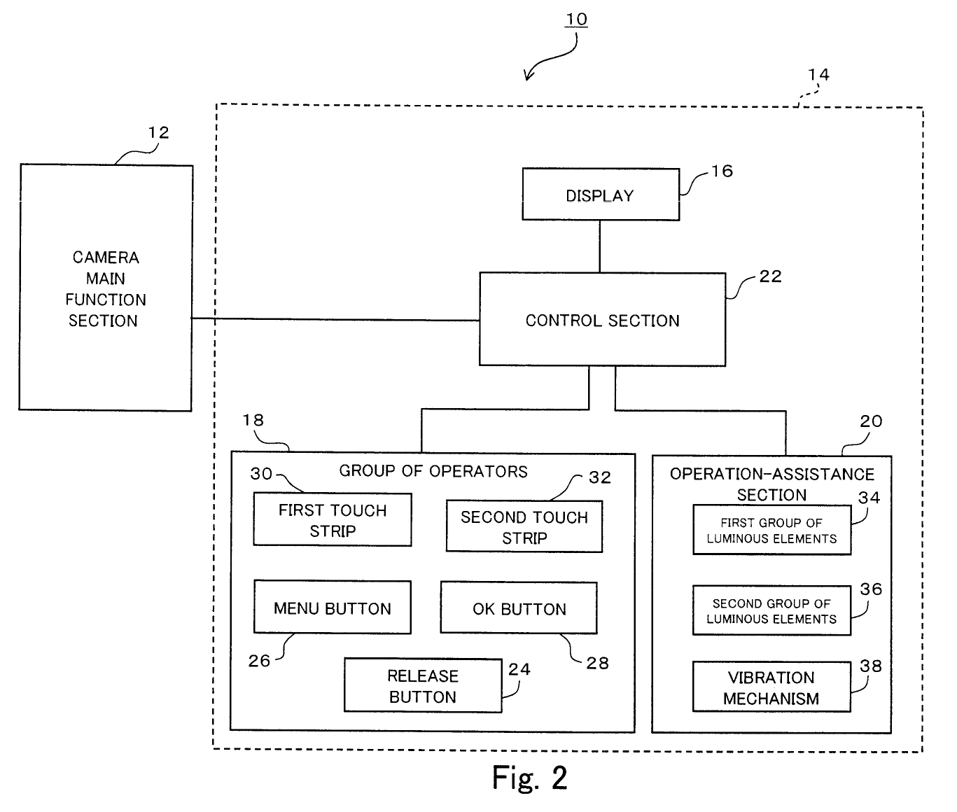

Embodiments of the present invention will be described hereinbelow by reference to the drawings. FIG. 1 is a rear view of a digital camera corresponding to an embodiment of the present invention. FIG. 2 is a block diagram showing the general configuration of the digital camera.

This digital camera 10 is coarsely divided into a camera main function section 12 for performing imaging operation, and a user interface section (hereinafter called a “UI section”) 14 for providing the user with information and accepting operation from the user. The camera main function section 12 is formed from an imaging optical system, an imaging element, a signal processing circuit, memory, and the like; and provides the principal functions of the camera. The specific configuration of this camera main function section 12 is analogous to that of a known digital camera, and hence a detailed description of the configuration will be omitted here.

The UI section 14 provides the user with information and accepts operation from the user. The UI section 14 includes a display 16 for displaying various items of information, a group of operators 18 used for accepting operation from the user, an operation-assistance section 20 for assisting the user's operation, and a control section 22 for controlling these sections.

The display 16 is formed from a slim display device such as an LCD and is provided on the back of the digital camera 10. In accordance with a command from the user, the display 16 displays a captured image, a preview image acquired at any time, and a menu setting screen to be described later. Contents displayed by the display 16 are controlled by the control section 22.

A release button 24, which is one operator constituting the group of operators 18, is depressed at the time of issuance of a command to capture an image. This release button 24 is placed in the vicinity of a right end on an upper surface of the digital camera 10. The reason why the release button 24 is provided in the vicinity of the right end is because a right-handed user can readily actuate the release button with his/her dominant hand.

A menu button 26, an OK button 28, and a pair of touch strips 30, 32 are operators used chiefly during setting of a menu. Setting of a menu means light source setting of white balance and setting of various operations of the digital camera 10 such as the size of a recorded image or the volume of camera operation sound. In the digital camera 10, a plurality of menu items have been defined in advance while being divided into a plurality of hierarchical levels. The user can set operation of a camera by means of selecting and determining the plurality of menu items, as required.

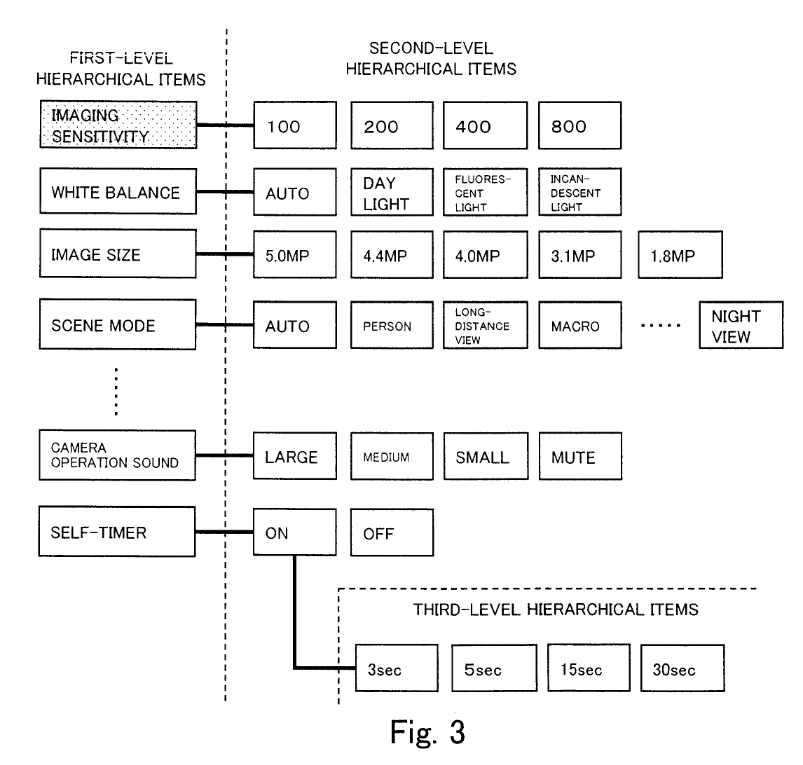

FIG. 3 is a view showing an example configuration of menu items. First-level hierarchical items correspond to highest-level hierarchical items, and a plurality of settable parameters are defined. Corresponding items are associated, as second-level hierarchical items, with the respective first-level hierarchical items. As is evident from FIG. 3, a plurality of second-level hierarchical items are usually associated with one first-level hierarchical item. For instance, four items; namely, parameters 100, 200, 400, and 800 which can be set as imaging sensitivity, are associated as second-level hierarchical items with one first-level hierarchical item “Imaging Sensitivity.”

When difficulty is encountered in making a setting by means of only the second-level hierarchical item, third-level hierarchical items are associated as lower-level items with the second-level hierarchical items. For instance, a first-level hierarchical item “self-timer” is associated with two items, as second-level hierarchical items: “ACTIVATION” of a self-timer and “DEACTIVATION” of the self-timer. Further, the second-level hierarchical item “ACTIVATION” is associated with, as third-level hierarchical items, settable wait times “3 sec,” “5 sec,” “15 sec,” and “30 sec.”

Turning back to FIGS. 1 and 2, the configuration of the digital camera 10 will be described. The menu button 26 is of depression type and is depressed at the time of initiation of menu setting operation. The menu button 26 is disposed in the vicinity of the first touch strip 30 to be described later; in other words, to the left of the display 16. When the menu button 26 is depressed, the control section 22 displays a menu setting screen on the display 16. The menu button 26 also acts as an operator which commands aborting of menu setting operation. Specifically, when the menu button 26 is depressed while the menu setting screen has already been displayed, the control section 22 determines that a command to abort menu setting operation has been issued by the user, and aborts displaying of the menu setting screen.

A first touch strip 30 is an operator which detects sliding action of the user's finger and is actuated during selection an item from an odd-numbered hierarchical layer and determination of the thus-selected item. A plurality of touch sensors 40 (or switches) for sensing the touch of the user's finger are arranged in the first touch strip 30 in a longitudinal direction thereof. The direction and speed of sliding action and the amount of the same are acquired from a change in the finger contact position detected by the plurality of contact sensors 40. The first touch strip 30 also detects previously-specified determination operation in addition to sliding action. Various forms of determination operation are conceivable; for example, operation for stopping sliding action, operation for lifting the finger off the first touch strip 30, operation for pressing the first touch strip 30, operation for clicking the first touch strip 30, and the like. In the present embodiment, operation for lifting the finger off the first touch strip 30 is detected as a determination operation. In accordance with the sliding action detected by the first touch strip 30 and the determination operation, the control section 22 performs selection and determination of an odd-numbered layer; namely, the first hierarchical layer or the third hierarchical layer. This will be described in detail later.

Like the first touch strip 30, a second touch strip 32 is also an operator for detecting sliding action of the user's finger. Consequently, a plurality of touch sensors 40 (or switches) for sensing the touch of the user's finger are arranged in the second touch strip 32 in a longitudinal direction thereof. The second touch strip 32 acquires the direction, speed, and amount of sliding action in accordance with a result of detection performed by the plurality of contact sensors 40. The second touch strip 32 detects, as a determination operation, operation for moving the finger off the second touch strip 32. In contrast with the first touch strip 30, the second touch strip 32 is actuated during selection and determination of even-numbered-level hierarchical items; namely, a second hierarchical layer or a fourth hierarchical layer (the fourth hierarchical layer is not provided in the present embodiment). Selection and determination of even-numbered-level hierarchical items utilizing the second touch strip 32 will be described in detail later.

Here, the OK button 28 is a push switch which is depressed at the time of final determination of menu items; in other words, the OK button 28 is a switch actuated at the end of menu setting operation. The OK button 28 is placed in the vicinity of the second touch strip 32; in other words, at the right of the display 16. When the OK button 28 is depressed after selection of lowermost-level hierarchical items, the control section 22 performs processing corresponding to settings indicated by the items selected at that point in time. When the OK button 28 is depressed while the lowermost-level hierarchical items have not yet been reached; for instance, when selection of only first-level hierarchical items has been performed, the control section 22 determines depression of the button as erroneous operation and ignores the depressing action.

The operation-assistance section 20 has a first group of luminous elements 34 disposed on the surface of the first touch strip 30; a group of second luminous elements 36 disposed on the surface of the second touch strip 32; and a vibration mechanism 38 for imparting vibrations to the digital camera 10. As shown in FIG. 1, the first group of luminous elements 34 is formed from a plurality of luminous elements 34a arranged in an essentially-circular-arc pattern on the surface of the first touch strip 30. The first group of luminous elements 34 is illuminated in accordance with the sliding action detected by the first touch strip 30 for the purpose of enhancing an ornamental characteristic. Even when actuation of the first touch strip 30 is determined to be desirable from the state of menu setting operation, the first group of luminous elements 34 is illuminated and also plays the role of guiding the user's operation. For instance, when the menu setting screen is displayed as a result of depression of the menu button 26, the first touch strip 30 must then be slid with the finger to thus select first-level hierarchical items. In this case, the first group of luminous elements 34 is illuminated at a point in time when the menu button 26 is depressed, thereby guiding the user's operation to the first touch strip 30.

As shown in FIG. 1, the second group of luminous elements 36 is formed from a plurality of luminous elements 36a arranged in an essentially-circular-arc pattern on the surface of the second touch strip 32. Like the first group of luminous elements 34, the second group of luminous elements 36 is also illuminated for enhancing ornamental characteristics and guiding the user's operation. For example, when the first-level hierarchical item has been determined and selected, the second touch strip 32 must then be actuated to thus select ascend-level hierarchical item. To this end, when the first-level hierarchical item has been determined, the second group of luminous elements 36 starts illuminating, to thereby guide the user's operation to the second touch strip 32.

The vibration mechanism 38 is a mechanism formed from a motor, a transmission mechanism, and the like (which are not shown), incorporated in the digital camera 10, and vibrations are imparted to the digital camera 10, as required, in accordance with the state of the menu setting operation. Specifically, in the present embodiment, the finger is slid over the first touch strip 30 or the second touch strip 32, whereupon selection items are sequentially switched. In synchronism with switching of a selection item, the vibration mechanism 38 imparts vibrations to the digital camera 10. The frequency and amplitude of vibrations to be imparted are changed according to the switching speed of the selection items. The user can ascertain switching of selection items not only in a visual manner but also in a tactile manner, by means of imparting vibrations in response to switching of a selection item. Consequently, the user's sense of operation can be enhanced. Even when drawing of the user's attention is desired, the vibration mechanism 38 imparts vibrations to the entire digital camera 10. For instance, when previously-defined special items have been selected from the plurality of selection items, the vibration mechanism 38 generates vibrations which are stronger than normal in order to draw the user's attention. Conceivable special items include items located at the end of a plurality of menu items arranged in a predetermined sequence.

Pursuant to the user's order input by way of the group of operators 18, the control section 22 controls driving of the operation-assistance section 20 and the display 16. Specifics of the user's command input by way of the group of operators 18 are reported to the camera main function section 12, as necessary.

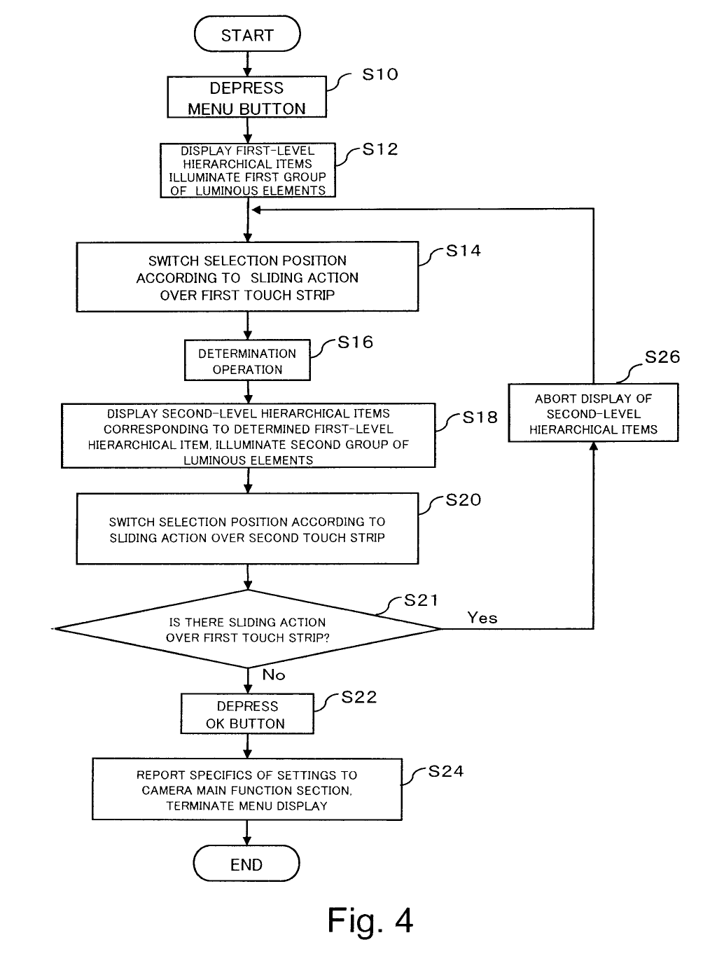

The flow of menu setting operation performed in the digital camera 10 will now be described. FIG. 4 is a flowchart showing the flow of menu setting. For the sake of simplifying explanations, there will be described only a case where items classified into two hierarchical layers are set.

When menu setting is performed, the user first depresses a menu button provided at the left of the display 16 (S10). The release button 24, which would be most frequently used in the digital camera 10, is positioned on the right of the display 16. Put another way, in the present embodiment, the menu button 26 used for commanding initiation of menu setting operation can be said to be located remotely from the release button 24. Therefore, the chance of erroneous operation; namely, erroneous depression of the menu button 26 during actuation of the release button 24, is less likely to arise. In the present embodiment, the menu button 26 serving as a button for initiating menu setting operation is a push switch which detects only depressing action. In contrast with contacting action to be sensed by the first touch strip 30 and the second touch strip 32, depressing action can be said to be unlikely to arise unless the user performs depressing action with definite intention. Therefore, the chance of the user erroneously depressing the menu button 26 is low, and occurrence of erroneous operation becomes less likely to arise.

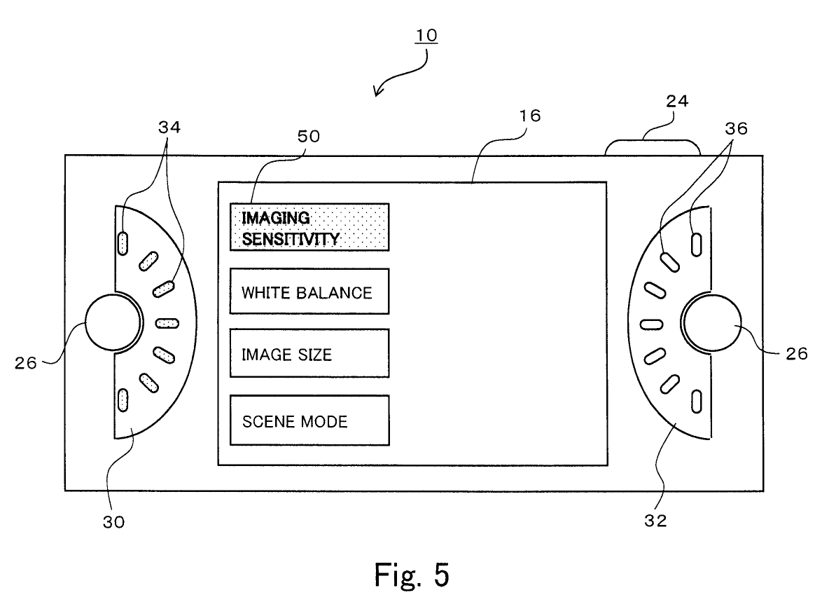

When depression of the menu button 26 has been detected, the control section 22 displays a plurality of first-level hierarchical items 50 on the display 16 and illuminates the first group of luminous elements (S12). FIG. 5 is a view showing the state of the display achieved at this time. As a result of illumination of the first group of luminous elements 34, the user can readily ascertain that an operator to be actuated next is the first touch strip 30.

As is evident from FIG. 5, the first-level hierarchical items 50 are displayed one above the other in the left position of the display screen in a predetermined sequence in the longitudinal direction. Of the plurality of first-level hierarchical items 50, only currently-selected items are displayed in a special form; for example, a highlighted form or the like. In the present embodiment, at a point in time when the menu button 26 is depressed, the item located at the top of the plurality of first-level hierarchical items 50 is highlighted as a selection item. The user slides his/her finger over the first touch strip 30 while ascertaining the displayed specifics, thereby switching a selection position. In synchronism with the sliding action detected by the first touch strip 30, the control section 22 sequentially switches the selection position (S14). The switching speed and direction of the selection position are changed according to the speed and direction of sliding action.

Moreover, the control section 22 illuminates the first group of luminous elements 34 in synchronism with switching of the selection position, and enhances an ornamental characteristic. Further, the vibration mechanism 38 induces vibrations in synchronism with switching of the selection position, thereby causing the user to ascertain switching of the selection position in a tactile manner. At this time, the frequency and amplitude of vibrations are changed according to the switching speed of the selection position. Moreover, when the selection position has reached the end of the plurality of first selection items 50 as a result of sequential switching of the selection position, the topmost selection item is again selected. At this time, in order to cause the user to ascertain that the plurality of first selection items 50 have been passed around to make a complete circuit, the vibration mechanism 38 induces vibrations which are stronger than normal.

When a desired first-level hierarchical item 50 has been selected by means of sliding action, the user performs determination operation. In the present embodiment, the determination operation is operation for lifting the finger from the first touch strip 30. When the determination operation; namely, the action of lifting the finger from the first touch strip 30, is detected, the control section 22 displays on the display 16 a plurality of second-level hierarchical items corresponding to the determined first-level hierarchical items. The first group of luminous elements 34 is extinguished, whilst the second group of luminous elements 36 is illuminated to thus guide the user's operation to the second touch strip 32 (S16, S18).

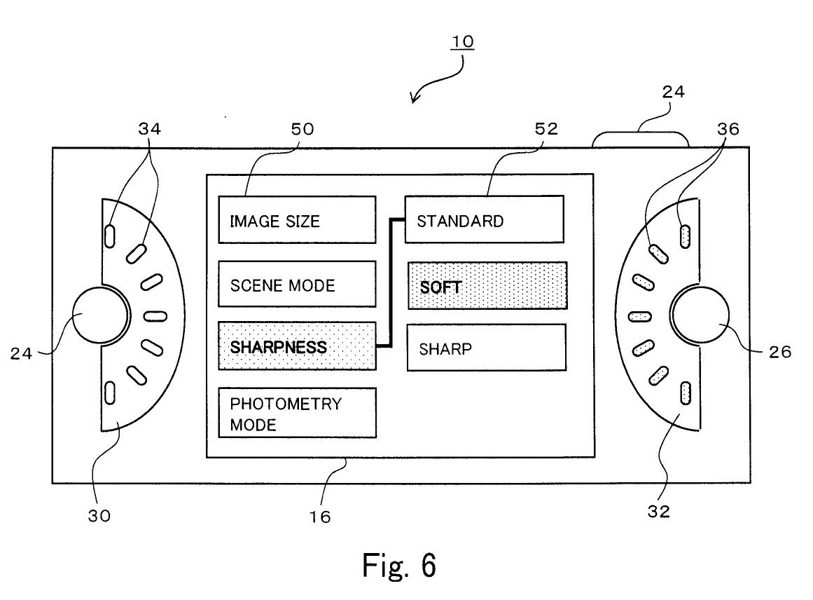

FIG. 6 is a view showing the state of the display achieved when the first-level hierarchical item has been determined. As is evident from FIG. 6, the second-level hierarchical items 52 are displayed in a predetermined sequence in the right area of the display screen in the longitudinal direction. At this time, correspondence between the first-level hierarchical item 50 and the second-level hierarchical item 52 is designated by a line interconnecting them.

Immediately after commencement of display of the second-level hierarchical elements 52, a set value achieved at this point in time is highlighted as a selection item. For instance, the first-level hierarchical item “sharpness” is associated, as second-level hierarchical items, with three items “standard,” “soft,” and “sharp” which can be set in connection with sharpness. When “sharpness” is set to “soft” at this point in time, “soft” is highlighted as a selection item at a point in time when display of the second-level hierarchical item 52 is started (i.e., a point in time corresponding to step S18). Specifically, the user can ascertain the current settings at a point in time when display of the second-level hierarchical items 52 is commenced.

When desiring to change the settings, the user slides his/her finger over the second touch strip 32. The control section 22 sequentially switches the selection position of the second-level hierarchical item 52 in accordance with the sliding action detected by the second touch strip 32 (S20). At this time, the second group of luminous elements 36 is illuminated in synchronism with switching of the selection position in order to enhance an ornamental characteristic. The vibration mechanism 38 induces vibrations in synchronism with switching of the selection position.

When a desired second-level hierarchical item has been selected, the user depresses the OK button 28 (S22). Upon detection of depression of the OK button 28, the control section 22 notifies the camera main function section 12 of settings indicated by the second-level hierarchical item 52 selected at that point in time, and terminates display of the menu setting screen (S24).

Determination of the second-level hierarchical item 52; in other words, final determination of settings, is performed not by operation of the second touch strip 32 but by operation of the OK button 28. The reason for adoption of such a structure is that the OK button 28 is a push switch and is less likely to cause erroneous operation as compared with the touch strips 30, 32 that detect even mere contact.

When sliding action of the first touch strip 30 has been detected with the second-level hierarchical item 52 displayed (S21), the control section 22 aborts display of the second-hierarchical item 52 (S26). In accordance with the sliding action detected by the first touch strip 30, the selection position of the first-level hierarchical item 50 is sequentially switched (S14). Specifically, when the second-level hierarchical item 52 is being displayed, the first touch strip 30 functions as an operator for canceling the once-rendered determination of the first-level hierarchical item 50. After the determination of the first-level hierarchical item 50 has been canceled, processing is again performed along the flow of processing pertaining to step S14 and steps subsequent thereto.

When the menu button 26 is depressed with the items being displayed (a state pertaining to steps S12 to S22), display of items is aborted regardless of a hierarchical level of the currently-displayed item, and menu setting is completed. Specifically, the menu button 26 acts not only as a button which instructs commencement of menu setting, but also as a button which instructs forceful termination of menu setting.

The flow of menu setting operation is as mentioned above. When menu setting operation is used, the user usually holds the digital camera 10 with both hands. At this time, in the present embodiment, the menu button 26 serving as an operator required to be actuated during menu setting operation, the two touch strips 30 and 32, and the OK button 28 are located at positions where they can be actuated by the thumbs of the user's hands holding the digital camera 10. Consequently, the user can perform menu setting while holding the digital camera 10 with both hands thereof; in other words, in a stable state. Although the menu button 26 and the OK button 28 are actuated solely at the beginning and end of the menu setting operation, the majority of the menu setting operation is performed by actuation of the two touch strips 30, 32. Consequently, the present embodiment is characterized in that the amount of movement of the fingers effected during the menu setting operation is small. By virtue of the small amount of movement of the fingers, the user does not need to visually ascertain each time the position of an operator is to be actuated next. Therefore, the user can readily perform menu setting even when continuously gazing at the display screen. Moreover, since the menu setting is simple, the chance of occurrence of erroneous operation can also be significantly diminished.

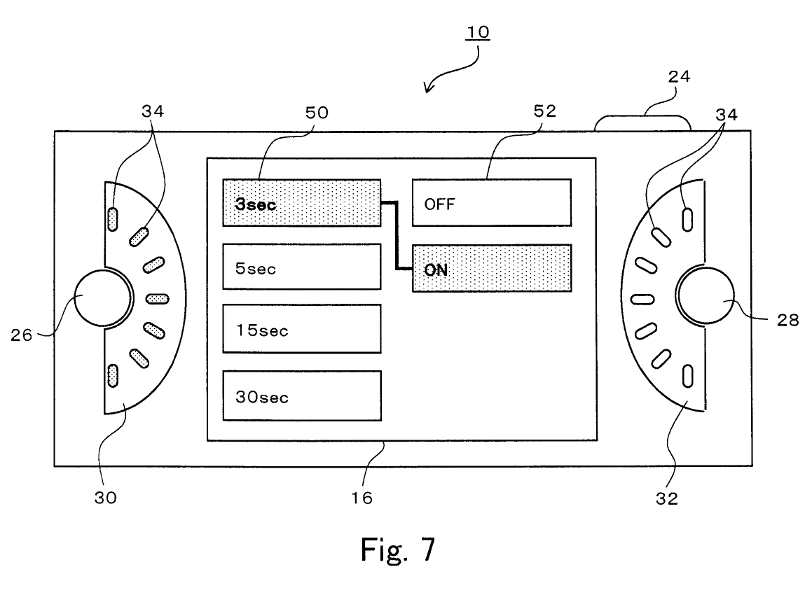

When items classified into a hierarchy of three layers or more are set; for example, when items pertaining to “self-timer” are set, the following flow is adopted. The user first selects and determines a first-level hierarchical item “self-timer” according to the flow of processing pertaining to steps S10 to S16 in FIG. 4. So long as the “self-timer” has been determined as the first-level hierarchical item, corresponding second-level hierarchical items “ON” and “OFF” are displayed at the right area of the display screen. When there is a desire to activate the self-timer, the user slides his/her finger over the second touch strip, to thus select “ON” as the second-level hierarchical item 52. In this state, the user performs predetermined determination operation on the second touch strip 32; namely, in the present embodiment operation for lifting the finger from the second touch strip 32. When the operation for lifting the finger has been detected, the control section 22 determines that “ON” has been determined as the second-level hierarchical item 52, and displays third-level hierarchical items 54 corresponding to “ON” in lieu of the first-level hierarchical item 50 appearing on the left side of the screen. FIG. 7 is a view showing the state of the display achieved at this time. When the third-level hierarchical items 54 are displayed, the control section 22 illuminates the first group of luminous elements 34 to thus guide the user's operation to the first touch strip 30. The user slides his/her finger over the first touch strip 30, to thereby sequentially switch the selection position of the third-level hierarchical item 54. When a desired third-level hierarchical item 54 has been selected, the OK button 28 is depressed to thus determine a desired third-level hierarchical item 54. Even in this case, the user can perform menu setting operation while holding the digital camera 10 with both hands, so that a strong holding characteristic can be maintained. Moreover, most of the menu setting operation is carried out by actuation of the two touch strips 30, 32. Therefore, shifting of the line of sight performed to ascertain the position of the operator is slight, and menu setting operation can be performed simply and accurately.

The present embodiment adopts a configuration where corresponding lower-level hierarchical items are not displayed until a high-level hierarchical item is determined. However, a corresponding low-level hierarchical item may also be displayed at a point in time when the high-level hierarchical item has been selected. Specifically, even when operation for determining the first-level hierarchical item 50 has not been performed, corresponding second-level hierarchical items 52 may also be displayed at a point in time when any of the first-level hierarchical items has been selected. In this case, the user can ascertain specifics of the second-level hierarchical items 52 associated with the respective first-level hierarchical items 50 without performing determination operation. In this case, it is desirable to be able to sequentially change the selection position of the second hierarchical item 52 without performance of predetermined determination operation, so long as sliding action over the second touch strip 32 has been detected. Put another way, in this case, it is desirable to enable omission of the determination operation. When the speed of sliding action over the first touch strip 30; in other words, the switching speed of the selection position of the first-level hierarchical item 50, is a certain level or more, the user encounters difficulty in ascertaining specifics of a second-level hierarchical item 52 corresponding to the selected first-level hierarchical item 50 even when the corresponding second hierarchical item 52 has been displayed. Consequently, when the selective switching speed of the first-level hierarchical item 50 is a given level or more, processing for displaying a corresponding second-level hierarchical item 52 may also be omitted.

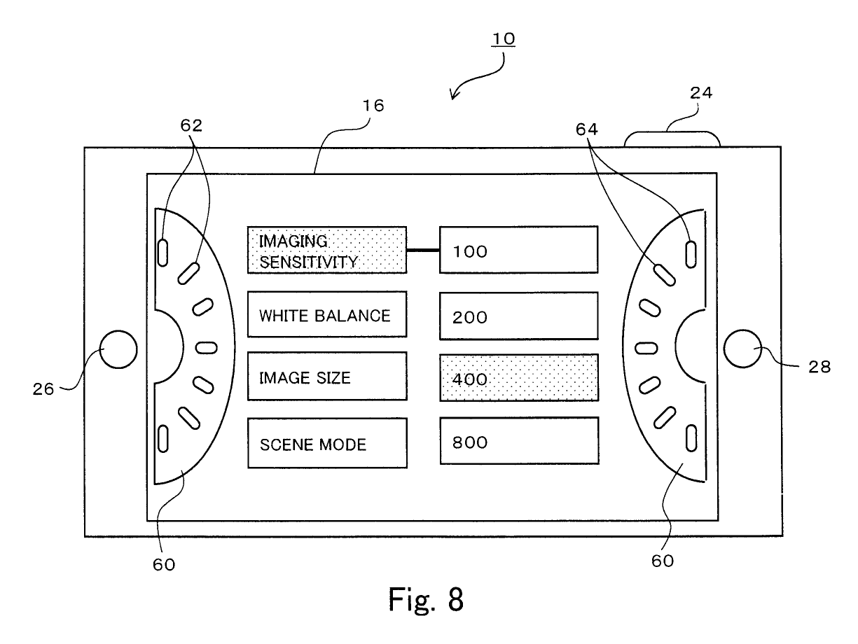

In the present embodiment, a touch strip is used as an operator for detecting sliding action of a finger. As a matter of course, another operator may also be used, so long as the sliding action is detectable. For instance, as shown in FIG. 8, areas around the respective side edges of the display 16 may also be configured so as to act as touch panels, and sliding action may be detected by means of the touch panels. In this case, figures 60 showing slidable areas are displayed on the display 16. Designs 62, 64 corresponding to the first group of luminous elements 34 and the second group of luminous elements 36 are also desirably displayed. As mentioned above, portions of the display 16 are taken as touch panels, and the touch panels are used as slide detection units, whereby spaces occupied by operators can be omitted. Consequently, the size of the display screen for displaying a captured image can be increased without involvement of an increase in the overall size of the digital camera 10.

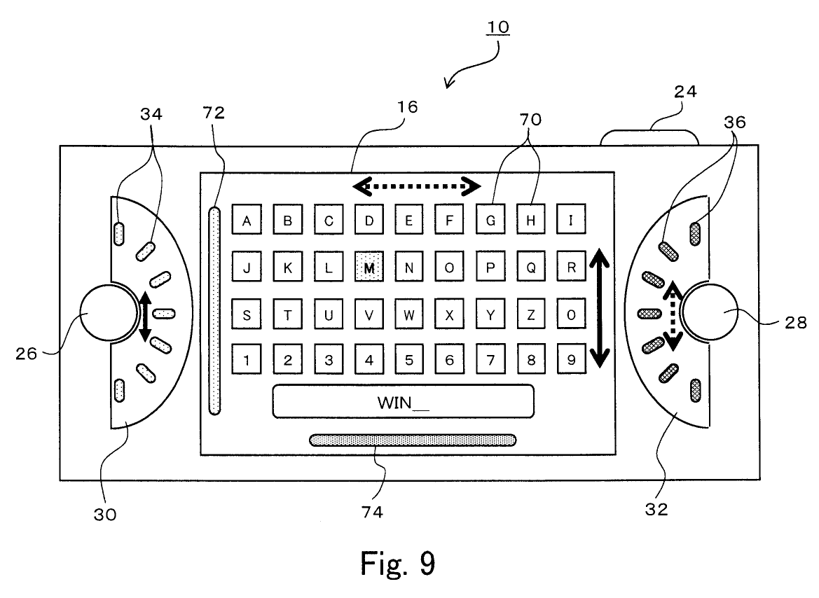

As a matter of course, the UI section 14 of the present embodiment is not limited to application to the digital camera but may also be applied to another portable electronic device; e.g., a game machine, a mobile communicator, a portable personal computer, or the like. The UI section 14 of the present embodiment may be used for operation other than menu setting operation. Operations for which the UI section 14 of the present embodiment can be preferably utilized include operation for selecting and determining a specific choice from choices arranged in a hierarchical layout as in the case of menu items, operation for selecting and determining a specific choice from a plurality of choices placed in the form of an array, and the like. Specifically, even when a desired key is selected from a plurality of keys displayed on the display 16 in the form of an array, the UI section of the present embodiment can be utilized preferably. FIG. 9 is a view showing the state of the display achieved at this time. A plurality of keys 70 are displayed in the form of an array on the display 16. In this case, it is better to cause the first touch strip 30 to act as an operator which moves a selection position (a highlighted position) in the longitudinal direction and the second touch strip 32 to act as another operator which moves the selection position in the lateral direction. Specifically, when the first touch strip 30 has detected sliding action, the control section 22 moves the selection position in the vertical direction. Meanwhile, when the second touch strip 32 has detected sliding action, the control section 22 moves the selection position in the horizontal direction. When a desired key can be selected as a result of sliding action of the two touch strips 30, 32, the user determines a key by means of depressing the OK button 28 and the like. With such a configuration, a desired key can be readily selected and determined from the plurality of keys without involvement of complicated button operations.

In this case, there is a problem of a relationship between each of the touch strips and the moving direction of the selection position being slightly difficult to understand. In order to solve this problem, the group of luminous elements 34, 36 provided on the surfaces of the respective touch strips 30, 32 may also be utilized. For instance, a vertical line 72 is displayed in red on the display 16, and a horizontal line 74 is displayed in green on the same. Further, the first group of luminous elements 34 arranged on the surface of the first touch strip 30 is displayed in red, and the second group of luminous elements 36 arranged on the surface of the second touch strip 32 are illuminated in green. In this case, the user can readily ascertain a relationship between the touch strips 30, 32 and the moving direction of the selection position by checking the colors of the groups of luminous elements 34, 36 arranged on the surfaces of the respective touch strips 30, 32 against the colors of lines 72, 74 displayed on the display 16.

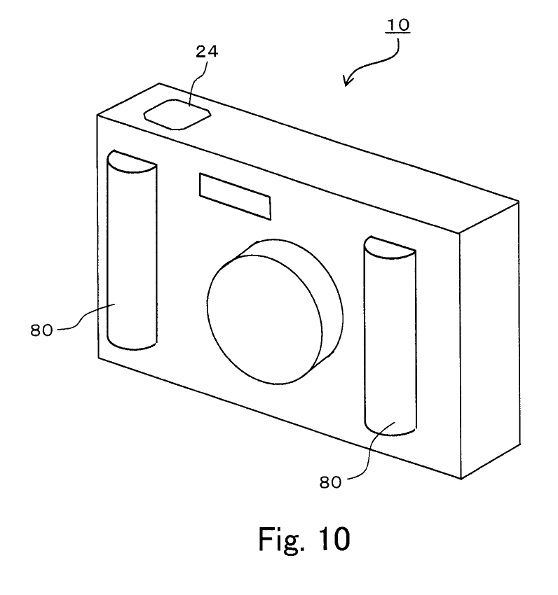

Although the above descriptions have not provided a particular explanation about the outer shape of the portable electronic device, the holding characteristic can be enhanced to a much greater extent by means of arranging grip-shaped protuberances 80 on the surface of the portable electronic device (a digital camera in the illustrated example), as shown in FIG. 10.

### PARTS LIST

10 digital camera
12 main function section
14 user interface section
16 display
18 operators
20 operation assistance section
22 control section
24 release button
26 menu button
28 OK button
30 touch strips
32 touch strips
34 first group luminous elements
34a plurality of luminous elements
36 second group luminous elements
36a plurality of luminous elements
38 vibration mechanism
40 touch sensors
50 first level hierarchical items
52 second level hierarchical items
54 third-level hierarchical items
62 designs
64 designs
70 keys
72 vertical line
74 horizontal line
100 parameters
200 parameters
400 parameters
800 parameters
S10 display
S12 first group luminous elements
S14 selection position
S16 second touch strip
S18 second touch strip
S20 second touch strip
S21 second level hierarchical items displayed
S22 OK button
S24 menu setting screen
S26 second-level hierarchical items

What is claimed is:

1. A user interface which is provided in a portable electronic device, provides a user with information, and accepts operation from the user, the interface comprising:
a display screen for displaying information;
first and second slide detection units which form a pair for detecting sliding action of a user's finger and placed in the vicinity of right and left side edges of a display screen; and
a control unit which displays a plurality of items on the display screen and sequentially switches a selection position of an item according to the sliding action detected by the slide detection units.

2. The user interface according to claim 1, wherein the plurality of items are classified into a plurality of hierarchical strata; and
the control unit sequentially switches a selection position of an odd-numbered hierarchical layer according to sliding action detected by the first slide detection unit and sequentially switches a selection position of an even-numbered hierarchical layer according to sliding action detected by the second slide detection unit.

3. The user interface according to claim 2, wherein the first and second slide detection units can detect previously-defined determination operation; and
the control unit specifies, as a determination item, a high-level hierarchical item selected at a point in time when the slide detection unit corresponding to the high-level hierarchical item has detected determination operation, and displays low-level hierarchical items corresponding to the determination item.

4. The user interface according to claim 3, wherein, when a slide detection unit corresponding to a high-level hierarchical item has detected sliding action during display of low-level hierarchical items, the control unit aborts the display of the low-level hierarchical items and sequentially switches selection position of a high-level hierarchical item according to the sliding action.

5. The user interface according to claim 2, wherein the control unit displays low-level hierarchical items corresponding to an item selected at a point in time when one is selected from the high-level hierarchical items.

6. The user interface according to claim 1, wherein the control unit displays the plurality of items arranged in an array on the display screen, moves the selection position of an item in a first direction according to the sliding action detected by the first slide detection unit, and moves the selection position of an item in a second direction differing from the first direction according to the sliding action detected by the second slide detection unit.

7. The user interface according to claim 1, further comprising:
a vibration unit which vibrates the overall user interface in synchronism with operation of the user detected by the respective slide detection units.

8. The user interface according to claim 5, wherein the vibration unit changes at least one of amplitude and frequency of vibrations according to the speed of detected sliding action of the user.

9. The user interface according to claim 1, further comprising a plurality of luminous elements disposed in the vicinity of the first slide detection unit and the second slide detection unit, wherein
the control unit causes a luminous element, which is located in the vicinity of a slide detection unit and is desired to be actuated by the user, to illuminate according to the state of current operation, thereby guiding user's operation.

10. A digital camera having a display screen, comprising:
a release button for accepting an imaging command from a user;
first and second slide detection units which form a pair for detecting sliding action of a user's finger and are placed in the vicinity of right and left side edges of a display screen; and
a control unit which displays on the display screen a plurality of items classified into a plurality of hierarchical strata, sequentially switches a selection position of an odd-numbered hierarchical item according to the sliding action detected by the first slide detection unit, and sequentially switches a selection position of an even-numbered hierarchical item according to sliding action detected by the second slide detection unit, wherein
the first slide detection unit is located more distance from the release button than is the second slide detection unit.
